(19) United States
(12) Patent Application Publication
(10) Pub. No.: US 2018/0052425 A1
(43) Pub. Date: Feb. 22, 2018

(54) DEVICE AND METHOD FOR NANOPARTICLE SIZING BASED ON TIME-RESOLVED ON-CHIP MICROSCOPY

(71) Applicant: THE REGENTS OF THE UNIVERSITY OF CALIFORNIA, Oakland, CA (US)

(72) Inventors: Aydogan Ozcan, Los Angeles, CA (US); Euan McLeod, Tucson, AZ (US); Tevfik Umut Dincer, Los Angeles, CA (US)

(73) Assignee: THE REGENTS OF THE UNIVERSITY OF CALIFORNIA, Oakland, CA (US)

(21) Appl. No.: 15/542,794

(22) PCT Filed: Jan. 22, 2016
(86) PCT No.: PCT/US16/14560

§ 371 Date: Jul. 11, 2017

Related U.S. Application Data
(60) Provisional application No. 62/106,614, filed on Jan. 22, 2015.

(51) Int. Cl. G03H 1/26; G01B 9/021

(52) U.S. Cl. CPC G03H 1/26; G03H 2001/261; G01B 9/021

(57) ABSTRACT

A method for the label-free sizing of small, nanometer-sized objects such as particles includes a hand-held, portable holographic microscope that incorporates vapor condensation of nanolenses and time-resolved lens-free imaging. The portable device is used to generate reconstructed, time-resolved, and automatically-focused phase images of the sample field-of-view. The peak phase value for each object a function of working distance (z₂) and condensation time (t) is used to measure object size. The sizing accuracy has been quantified in both monodisperse and heterogeneous particle solutions, achieving an accuracy of +/−11 nm for particles that range from 40 nm up to 500 nm. For larger particles, the technique still works while the accuracy roughly scales with particle size.

### RELATED APPLICATION

This Application claims priority to U.S. Provisional Patent Application No. 62/106,614 filed on Jan. 22, 2015, which is hereby incorporated by reference in its entirety. Priority is claimed pursuant to 35 U.S.C. §119 and any other applicable statute.

### STATEMENT REGARDING FEDERALLY SPONSORED RESEARCH AND DEVELOPMENT

This invention was made with Government support under W911NF-13-1-0419, awarded by the U.S. Army, Army Research Office. The Government has certain rights in the invention.

### TECHNICAL FIELD

The technical field generally relates to devices and methods used to detect and size small particles and, in particular, nanoparticles.

### BACKGROUND OF THE INVENTION

The ability to detect and size nanoparticles is extremely important in the analysis of liquid and aerosol samples for medical, biological, and environmental studies. Some examples of nanoparticles that researchers have been interested in detecting and sizing include viruses, exosomes, metallic labels, soot, ice crystals in clouds, and engineered nanomaterials, among others. While there are various nanoparticle detection and sizing methods, there is a lack of high-throughput instruments that can cover a large dynamic range of particle sizes and concentrations within a field-portable, cost-effective and rapid interface. Existing non-optical methods, such as transmission electron microscopy (TEM), scanning electron microscopy (SEM), and atomic force microscopy, are typically very accurate and provide a gold standard for particle sizing; however they are bulky, require significant capital investment, can be slow in image acquisition, and provide extremely restricted fields of view (FOVs) that limit throughput for particle sizing. Optical techniques can be more cost-effective and rapid, however it is in general difficult to overcome the challenge of obtaining a large enough signal-to-noise (SNR) ratio to detect and reliably size both individual nanoparticles and populations of nanoparticles.

One way in which the challenge of low SNR has been mitigated is through the use of fluorescent labels, although the chemistry of the detected particles must be known a priori so that they can be efficiently and specifically labeled with fluorophores or quantum dots. Fluorescent optical techniques include fluorescence correlation spectroscopy, fluorescence flow cytometry, and recently-developed super-resolution techniques such as photo-activated localization microscopy (PALM), stochastic optical reconstruction microscopy (STORM), and stimulated emission depletion (STED) microscopy. Although these techniques can provide accurate sizing data, they too suffer from many of the drawbacks of the non-optical methods: bulkiness, capital cost, relatively slow imaging speed as well as significantly restricted FOVs, which limit the sizing throughput.

Label-free non-fluorescent optical methods, on the other hand, have the advantage to quantify particle size distributions in chemically or biologically unknown heterogeneous samples. For particles in liquids, two common techniques are dynamic light scattering (DLS) and nanoparticle tracking analysis (NTA), both of which characterize suspensions of particles using Brownian motion. Because it is a statistical method, DLS only provides collective sizing data about particles' hydrodynamic diameters, without providing sizing information on an individual particle-by-particle basis. As a result of this, DLS has limited accuracy for poly-disperse samples with size heterogeneity, and in particular has difficulty resolving bimodal (or multi-modal) distributions where the modal means are either too closely spaced or too far apart. In contrast, NTA tracks individual particles and can therefore better resolve different sizes in particle distributions. However, both DLS and NTA tend to rely on bulky equipment, are limited in the range of particle concentrations they can handle (e.g., too much dilution results in low signal, while high density results in high noise due to multiple scattering events), and require sufficiently small particles (less than a few microns in diameter) such that the Brownian motion is noticeable, which limits the dynamic range of particle sizes that can be probed with these techniques.

For aerosol measurements, several other label-free non-fluorescent nanoparticle sizing techniques are available, including differential mobility analysis, condensation particle counting, laser diffraction, and diffusion size classification. Laser diffraction simply observes the diffracted laser intensity of particles flowing through a chamber. However, because scattered intensity scales with the sixth power of a nanoparticle's diameter, it is difficult for this approach to detect particles smaller than ˜100 nm. A condensation particle counter enables detection of ultra-small nanoparticles, and overcomes this challenge by using the particles of interest as nuclei for the condensation of a vapor around particles while they are still suspended in the gas flow. This approach effectively increases the particles' sizes, making them easier to detect, although sizing accuracy may be compromised due to differing condensation rates around particles of different sizes. To provide higher sizing accuracy, laser diffraction and condensation particle counting can be combined with differential mobility analysis, which separates airborne particles based on size by first charging the particles, and then characterizing their mobility within an electric field. The resulting measurements depend on the electrical properties of the particles as well as their size. This technique exists in both large laboratory-based platforms, as well as relatively small platforms.

For nanoparticle sizing measurements in either liquids or aerosols, holographic imaging provides an attractive label-free optical approach. Because holography captures particles' scattered fields through an interference pattern, measured signals scale with the third power of the of the particle diameter instead of the sixth power that is characteristic of the scattered intensity measurements discussed earlier. This endows holography with better signal scaling when detecting small particles. Furthermore, holographic microscopy provides quantitative information on both particle amplitude (e.g., absorption) as well as phase (e.g., refractive index), which can be used in concert to improve sizing accuracy. Nonetheless, low SNR remains a challenge for detecting and sizing particularly small particles, and holographic imaging has historically been used for particle sizing at the micro-scale, generally in conjunction with large bulky laboratory equipment, such as laboratory grade optical microscopes with relatively expensive objective lenses.

More recently, lens-free holographic imaging platforms have been developed where the sample of interest is placed on an opto-electronic sensor-array with typically less than 0.5 mm gap (z₂) between the sample and sensor planes such that under unit magnification the entire sensor active area serves as the imaging FOV, easily reaching >20-30 mm² with state-of-the-art CMOS imager chips. The initial sensitivity limit of this lens-free on-chip imaging approach has been ˜200-300 nm; particles with diameters smaller than this are indistinguishable from background noise. Recently, it has been shown that different methods of generating self-assembled nanolenses allow one to detect, using on-chip holographic imaging, particles as small as ˜40 nm; however this is without sizing capability.

### SUMMARY

In one embodiment, a device for the imaging and sizing of objects incorporates tunable vapor condensation of nanolenses and time-resolved lens-free holographic imaging in a single portable, hand-held device. Using this portable device and the reconstructed, time-resolved, and automatically-focused phase images of the sample field-of-view, platform is able to count and size nanometer-sized objects. The platform works with larger particle sizes as well (e.g., millimeter sized objects). Compared to other nanoparticle sizing approaches in general, the lens-free holographic imaging and vapor condensation platform provides highly advantageous features including: label-free protocols, an ultra-large particle sizing range (˜40 nm to millimeter-scale), an imaging-based approach that provides particle localization in addition to sizing information, field-portability, cost-effectiveness, and a large field of view that can handle a wide range of particle concentrations (spanning up to 6 orders of magnitude), as well as the potential to achieve spatially multiplexed detection and sizing of different target nanometer-sized particles over a large area by patterning different capture zones.

In another embodiment, a device for the imaging and sizing of objects within a sample includes a housing having an interior volume therein and an image sensor disposed in an upper portion of the housing and having an active region facing towards the interior volume. A sample holder having a lower surface that contains the objects thereon is insertable into the housing adjacent to the active region of the image sensor. A fluid chamber is disposed in the housing and exposed to the interior volume and has a heating element therein, the fluid chamber configured to hold a liquid therein. The heating element heats the fluid to evaporate the fluid or form vapor that resides in the internal volume of the device. An array of spatially separated light sources is disposed in the housing and defines an optical path between the array of spatially separated light sources and the active region of the image sensor, wherein the sample holder, when inserted, is positioned within the optical path. The spatially separated light sources are individually turned ON/OFF to acquire raw, low resolution holographic images of the objects. These raw images are transferred to a separate computing device having one or more processors configured to generate time-resolved, super-resolution holograms from a plurality of low-resolution image frames obtained of the objects by the image sensor when illuminated by the spatially separated light sources. Peak phase values are extracted from phase image reconstructions obtained from the super-resolution holograms, wherein the one or more processors outputs a size of the objects based on the peak phase values. A calibration curve or look-up table that is empirically derived is used to translate peak phase values into object sizes.

In another embodiment, a method of imaging and sizing objects includes loading the objects on a substrate and subjecting the substrate to evaporated liquid that forms nanolenses over the objects. A plurality of low-resolution image frames of the objects are obtained at multiple times t using an array of spatially separated light sources and an image sensor, wherein the objects of interest are located within an optical path between the spatially separated light sources and the image sensor. A super-resolved hologram is generated from a plurality of low-resolution image frames obtained of the objects by the image sensor obtained at the multiple times t. The super-resolved hologram is back-propagated to multiple z₂ distances and phase images of the objects are recovered and objects are counted that have a phase value over a threshold value. The already counted objects are masked and the phase value of remaining objects is measured and objects having a phase value over a reduced threshold are counted, wherein this step is repeated a plurality of times. The peak phase values for each object for all z₂ and t values are merged and a focusing criterion is applied to remove spurious objects based on z₂ values. The peak phase value for remaining non-spurious objects are identified and the respective sizes of the non-spurious objects are outputted based on the identified peak phase value. A calibration curve or look-up table that is empirically derived is used to translate peak phase values into object sizes.

In another embodiment, a device for the imaging and sizing of objects within a sample includes a housing having an interior volume therein; an image sensor disposed in the housing and having an active region facing towards the interior volume; a sample holder having a surface that contains the objects thereon, the sample holder insertable into the housing adjacent to the active region of the image sensor; and a fluid chamber disposed in the housing and exposed to the interior volume and having a heating element therein, the fluid chamber configured to hold a liquid therein. The device includes either a single light source or an array of spatially separated light sources disposed in the housing and defining an optical path between the array of spatially separated light sources and the active region of the image sensor, wherein the sample holder, when inserted, is positioned within the optical path.

### BRIEF DESCRIPTION OF THE DRAWINGS

FIG. 1A illustrates one embodiment of a hand-held device that is used to count and size objects such as particles. The hand-held device is portable (e.g., weighs less than 500 grams).

FIG. 1B illustrates a partially exploded, cutaway view of the interior of the hand-held device of FIG. 1A showing the interior components thereof.

FIG. 1C illustrates a sample holder containing small objects thereon.

FIG. 1D illustrates the hand-held device coupled to a computing device that is used to reconstruct images obtained from the hand-held device as well count and size or measure objects.

FIG. 2 illustrates an exemplary graphical user interface (GUI) that can be utilized in connection with the computing device of FIG. 1D. The GUI in this embodiment is able to present images to the user (raw images, super-resolved holograms, reconstructed phase images, amplitude images, phase values as a function of time, as well as a variety of user options.

FIG. 3 illustrates a flow chart of one embodiment of an automated object sizing algorithm that is used to count and size objects within a sample.

FIG. 4A illustrates a graph comparison showing experimental and simulated signals as a function of time for an 83 nm bead (illumination wavelength: 510 nm). Horizontal experimental error bars show the total time required to capture the set of low-resolution holograms that are used to synthesize a pixel super-resolved holographic image. Vertical experimental error bars have a length equal to twice the maximum difference in phase value between the brightest pixel and its four nearest neighbors for a given reconstructed lens-free particle image. The vertical span of solid curve depicts the standard deviation of eight simulations run with different random noise.

FIG. 4B illustrates the simulated nanolens shape at the experimental time points from FIG. 4A for a spherical bead.

FIG. 5A illustrates the reconstructed peak phase as a function of true particle diameter measured using SEM. Experimental measurements from 122 beads are shown (circles), along with the simulation predictions based on a theoretical model, and an empirical fit that is used to calibrate the system for particle sizing.

FIG. 5B illustrates the calibration error in particle sizing given by the horizontal difference between the true particle diameter and the empirical curve in FIG. 5A. For nanoparticles in the 40-500 nm range, the root-mean-square-error (RMSE) is 11 nm.

FIG. 6A illustrates the sizing results (histogram) of 50 nm polystyrene beads.

FIG. 6B illustrates the sizing results (histogram) of 100 nm polystyrene beads.

FIG. 6C illustrates the sizing results (histogram) of a mixture of 100 nm and 250 nm polystyrene beads.

FIG. 6D illustrates the sizing results (histogram) of a mixture of 50 nm, 140 nm, 250 nm, and 500 nm polystyrene beads.

FIG. 6E illustrates the sizing results (histogram) of gadolinium-silica nanocrescents. The TEM histogram inset FIG. 6E is the result of manual TEM measurements of the longest nanocrescent dimension. Based on SEM measurements, the mean sizes, standard errors of the mean, and standard deviation of the bead populations are, 50 nm: mean=49+/−1.1 nm, σ=4.3 nm; 100 nm: mean=101+/−2.6 nm, σ=9.4 nm; 140 nm: mean=129+/−0.8 nm, σ=4.1 nm; 250 nm: mean=234+/−3.7 nm, σ=12.7 nm; 500 nm: mean=489+/−1.4 nm, σ=5.3 nm.

FIG. 6F illustrates the sizing results (histogram) of Ad5 adenovirus particles with sizes that range from 50-80 nm. Insets show electron microscope images of typical particles. All scale bars are 100 nm.

FIG. 7A illustrates a phase reconstruction image before the iterative count-and-clean procedure is used to iteratively remove larger objects before attempting to detect and size smaller objects. A large particle is visible at the top-right with significant holographic twin-image noise.

FIG. 7B illustrates a phase reconstruction image after four (4) iterations of the count-and-clean procedure. Two smaller particles that were previously buried in the twin image noise are now clearly visible.

FIG. 7C illustrates a graph of peak phase as a function of z₂ value for a legitimate particle. A true particle comes into focus at an optimal z₂ value as represented by the parabolic fitting curve.

FIG. 7D illustrates a graph of peak phase as a function of z₂ value for a spurious particle. Spurious particle-like features do not exhibit a clear optimum reconstruction z₂, even though reconstruction images at specific z₂ values individually look very similar to those in FIG. 7C.

### DETAILED DESCRIPTION OF THE ILLUSTRATED EMBODIMENTS

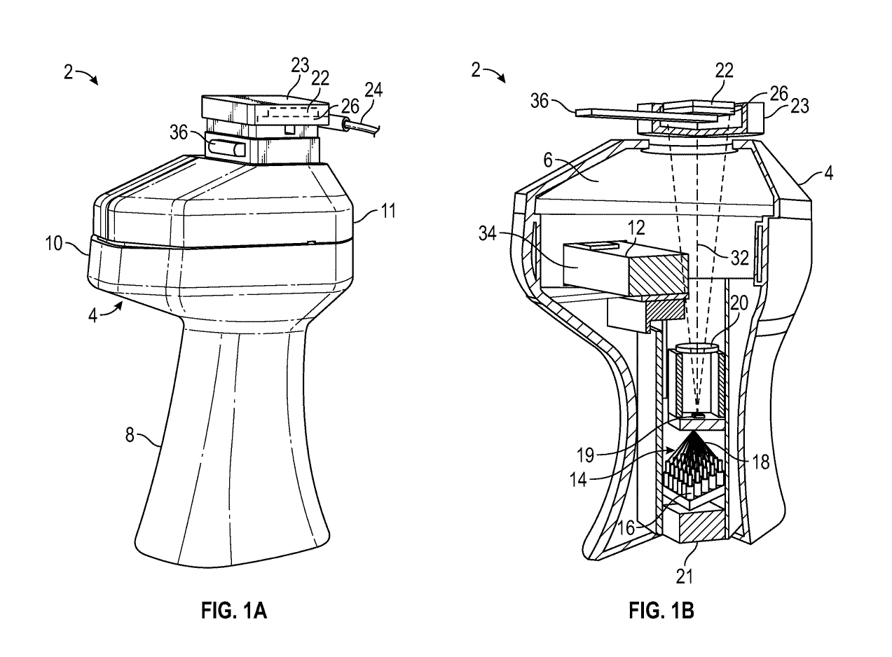

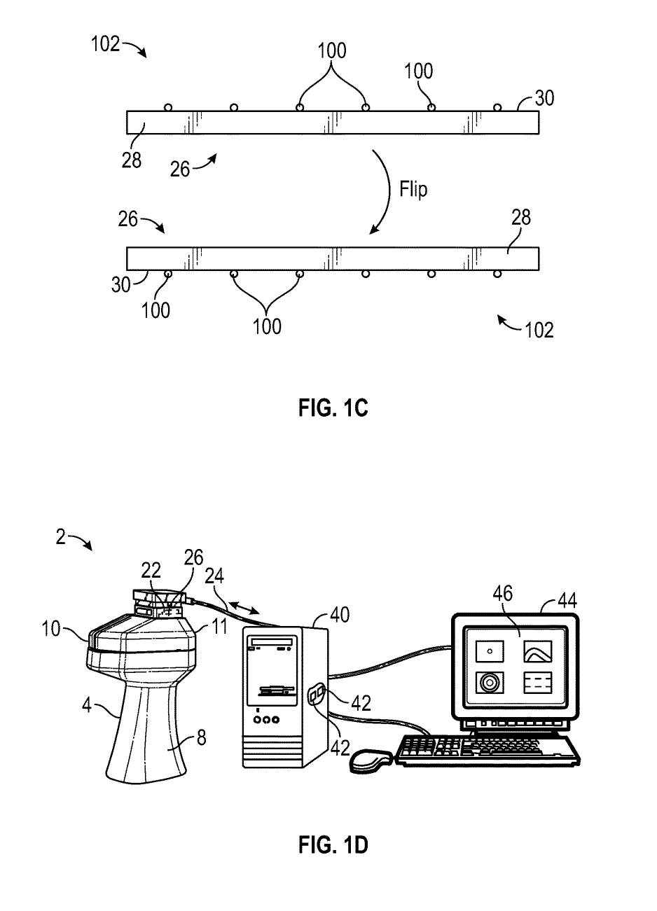

FIG. 1A illustrates a device 2 for the imaging and sizing of small objects 100 (FIG. 1C) within a sample. As described herein, the terms object or objects includes small sized objects such as particles that range from nanometer sized particles (e.g., those less than about 100 nm) up to larger sized particles (e.g., millimeter scale). The device 2 includes a housing 4 that includes an interior volume 6 (seen in FIG. 1B) therein that houses the various components of the device 2. The housing 4 is relatively small and is hand-held and portable. The housing 4 may include a grip portion 8 that is ergonomically designed so that the hand of the user can readily grip and hold the device 2. As illustrated in FIGS. 1A and 1B, an upper region 10 of the housing 4 above the grip portion extends outwardly. The upper region 10 of the housing 4 may be opened whereby the upper region 10 includes an upper cap 11 portion that can be removed from the lower portion which allows for the loading of fluid into the device. As explained below, the interior of the upper region 10 of the housing contains a fluid chamber 12 that is located outside an optical path 32 (FIG. 1B) of the device 2 and contains a fluid therein that is used to form nanolenses around the objects 100.

The housing 4 may be made from a lightweight material such as a polymer or plastic material. The housing 4 may be made using 3D printing although other known manufacturing methods (e.g., molding, casting, or the like) may be used. As explained above, the device 2 is portable and hand-held. For example, the device 2 may weigh less than 500 grams in total. The device 2 includes a plurality of spatially separated light sources 14 that are used to illuminate the objects 100 contained within a sample 102 as explained herein. The light sources 14 as illustrated in FIG. 1B include separate light emitting diodes (LEDs) 16 with each LED 16 coupled to multi-mode optical fibers 18. The multi-mode optical fibers 18 terminate in an array of spatially separated fibers 19 that act to provide an array of light sources wherein individual LEDs 16 that emit light at different locations can be turned on/off. The array of spatially separated fibers 19 is a one dimensional array that is oriented at a diagonal with respect to the active surface of the image sensor 22 so that x and y shifts of the detected hologram are produced that are used in the super pixel reconstruction process. The LEDs 16 may emit light in a variety of different colors although green LEDs 16 were used in the experiments described herein. In addition, the number of LEDs 16 may vary although experiments were conducted using seventeen (17) such LEDs 16. As seen in FIG. 1B, an optical bandpass filter 20 (e.g., a thin-film based interference filter) is provided in the housing 4 and is used to provide partial temporal coherence to the light illuminates the objects 100 within the sample 102. The LEDs 16 may be powered by a power source 21 (e.g., batteries) that is contained within the housing 4. Alternatively, the LEDs 16 may be powered through a USB or other cable connected to a computing device 40.

Still referring to FIG. 1B, the device 2 includes an image sensor 22 that is located in the upper region 10 of the housing 4. The image sensor 22 is oriented to place its active region (that receives the light) facing in a downward orientation toward the light sources 14. The image sensor 22 may include, for example, a 10 mega-pixel complementary metal-oxide-semiconductor (CMOS) image sensor 22 although the invention is not limited to this specific sensor. The image sensor 22 is coupled to a cable 24 that is used to transfer raw image files to a computing device 40 as explained below. The image sensor 22 may be powered via the power source 21 contained in the device 2 or, alternatively, the power from the computing device 40 may be used to provide power to the image sensor 22.

FIG. 1C illustrates a sample holder 26 that is used to insert a sample 102 into the device 2 to identify and measure small objects 100 contained therein. The sample holder 26 includes an optically transparent substrate 28 such as glass or plastic. For example, the sample holder 26 may include a microscope slide or cover glass that is plasma treated. The sample 100 is placed on a surface 30 of the substrate 28 and the substrate 28 is flipped so that the sample 100 is on the lower surface 30 of the substrate 28. For sample preparation, the objects 12 contained in the sample 100 are adsorbed to the lower surface 30. The adsorption of the objects 100 may occur in a “dry” state; for example measuring particulate matter from the air that deposits on the substrate 28. Alternatively, the objects 100 may be adsorbed to the surface 30 in a wet state that is later dried or allowed to dry prior to insertion into the device 2. The sample holder 26 may have different zones or regions located on the substrate 28 that hold different samples. In addition, the sample holder 26 may having binding sites located thereon (e.g., molecules or chemical moieties) that bind to specific objects 100. These binding sites may be patterned on the sample holder 26 with their positions known so that spatially multiplexed detection and sizing of the objects 100 may be performed over a large area of the substrate 28.

The sample holder 26 is then loaded into the housing 4 in a position whereby the upper surface of the substrate 28 is in contact or immediately adjacent to the active region of the image sensor 22. To load the sample holder 26 a removable cap 23 may be provided that is secured to the image sensor 22. The cap 23 and image sensor 22 can be removed from the housing 4. The sample holder 26 can then be placed on a support surface in the housing 4 and the cap 23 and image sensor 22 placed back onto the housing 4. Alternatively, a slot or the like can be formed in the housing 4 whereby the sample holder 26 slides in laterally to position the sample 102 within interior volume 6.

With reference to FIG. 1B, an optical path 32 is formed between the array of spatially separated fibers 18 and the image sensor 22. Within this optical path 32 are located the optical bandpass filter 20 and the sample holder 26. As noted above, the interior of the upper region 10 of the housing contains a fluid chamber 12 that is located outside an optical path 32 of the device 2. The fluid chamber 12 is a dish, reservoir, or well that includes an upper surface that is open such that evaporated fluid that is contained in the fluid chamber 12 can fill the interior volume 6 of the housing 4 and condense on the lower surface 30 of the substrate 28 to form the nanolenses around the objects 100. A resistive heater 34 is located in the bottom of the fluid chamber 12 that is used to heat and evaporate the fluid contained therein. The resistive heater 34 may be powered by the power source 21. In one aspect of the invention, the fluid that is contained in the fluid chamber 12 is a polymer solution, for example, polyethylene glycol (PEG). The PEG solution may contain PEG having different molecular weights (different PEG solutions have different surface properties and the nanolenses that are formed thereby have different properties). A non-polymer fluid such as water may also be used although the condensation of water into nanolenses does not work as well as PEG. Importantly, the fluid chamber 12 is located inside the housing 4 but is located outside of the optical path 32 so it does not interfere with the imaging process. Optionally, a moveable shutter 36 may be incorporated into the housing 4 such that access to the lower surface 30 of the substrate 28 may be isolated from the evaporated fluid that is used to form the nanolenses around the objects 100. For example, the shutter 36 may be able to move in and out of the housing 4 to selectively expose or isolate the vapor from the sample holder 26.

In an alternative embodiment, the image sensor 22 may me positioned at a different location within the housing 4 such as the bottom with the array of spatially separated fibers 18 located on an opposing side of the housing 4 (e.g., upper portion of interior volume 6). All that is required is that an optical path is formed between the image sensor 22 and the array of spatially separated fibers 18 with the fluid chamber 12 not obstructing this path. In still another alternative embodiment, there is a single light source instead of a plurality of spatially separated light sources 14. This embodiment may be used where there are large objects 100 that are being imaged where pixel super resolution imaging is not needed. In such a case, only a single light source is needed. In one aspect, only a single light source (e.g., LED 16) of a plurality is turned on. For example, even though the device 2 may include an array of spatially separated fibers 18, only one may be used to illuminate the sample.

FIG. 1D illustrates the hand-held device coupled to a computing device 40 that is used to reconstruct images obtained from the hand-held device as well count and size or measure objects. The computing device 40 includes one or more processors 42 therein and runs the software that identifies and measures the objects 100 as described herein. The software (e.g., LabVIEW) is also used to control, for example, various operating parameters of the hand-held device 2. For example, the computing device 40 can be used to control the illumination sequence of the LEDs 16 and also control the temperature ramp and set point temperature of the fluid chamber 12. The computing device 40 may include a dedicated personal computer or laptop although it may also include other types of computing devices 40 such as tablet PCs, tablets, Smartphones and the like. The computing device 40 includes or is associated with a display 44 that presents to the user a graphical user interface (GUI) 46 that is used to display results of the imaging process as well as adjust or control options used during the imaging and measuring process. While FIGS. 1A and 1D illustrate a cable 24 connecting the device 2 to the computing device 40 in other embodiments data and instructions may be passed between the two devices using a wireless connection (e.g., Bluetooth or the like).

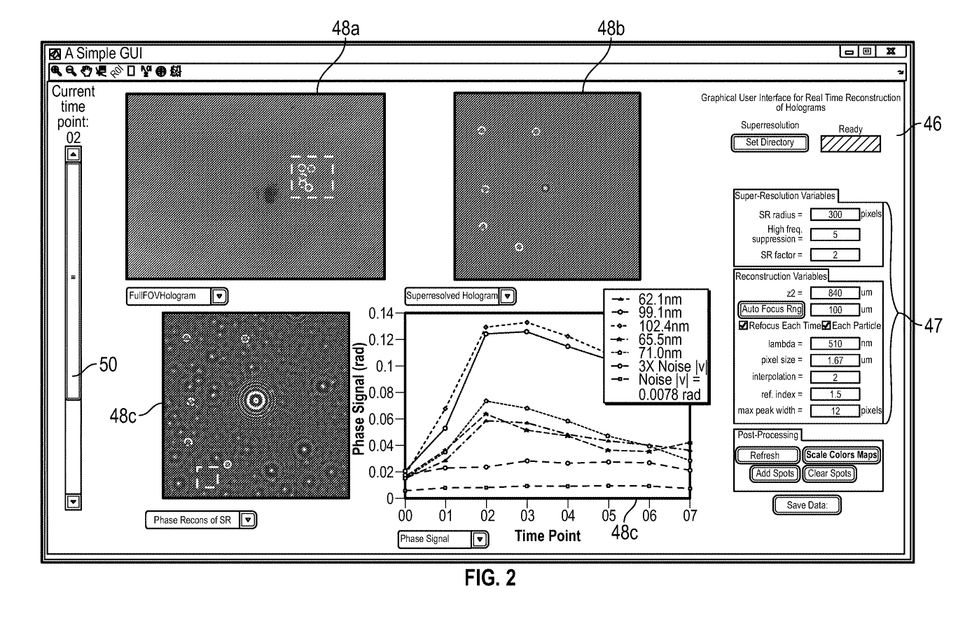

FIG. 2 illustrates an exemplary graphical user interface (GUI) 46 that can be utilized in connection with the computing device 40 of FIG. 1C. The GUI 46 in this embodiment is able to present a large amount of information rapidly and in a convenient fashion, including the raw low-resolution holograms, high-resolution holograms synthesized using pixel super resolution, digitally-reconstructed images of the sample, and time-traces of the signal from individual particles during the course of the experiment. The same interface also automatically compensates for possible mechanical drifts in the x, y, and z directions of the sample between different time points. As seen in FIG. 2, the GUI 46 includes image panels 48a, 48b, 48c for displaying images. This includes raw images 48a, super-resolved holograms 48b, and processed reconstructed images 48c (phase and amplitude). The GUI 46 also displays a graph 48c of the phase signal as a function of time for each object 100 that is detected on the sample holder 26. Various user options 47 may also be presented which can be altered or adjusted by the user. These include, the super resolution radius (SR radius), high frequency suppression for noise reduction, super resolution factor (SR factor), image reconstruction variables such as z₂ depth, autofocus settings, illumination wavelength, pixel size of the image sensor 22, interpolation factor, and refractive index of the sample holder 26. The GUI 46 also includes a slider bar 50 that can be used to select the particular time point for images and results. The user can thus readily move in the time domain to see how images and data (e.g., phase value) change. For example, the user can focus on a particular object 100 (or multiple objects 100) and quickly investigate how images and parameters change over time.

During operation of the device, the resistive heater 34 heats the fluid contained in the fluid container 12 whereby the fluid evaporates into a vapor. This vapor will then condense on the cooler surface 30 of the sample holder 26. As the fluid condenses on the sample, it forms a continuous film that thickens over time. In the vicinity of the small objects 100 (e.g., objects 12 sized in the nanometer range) adsorbed on the surface 30, this continuous film rises in the form of a rises in the form of a meniscus that acts as a nanolens that increases the scattering from the object 100 and helps to direct light toward the image sensor, thereby boosting the object's heterodyne holographic signature. This increase in holographic signature enables the detection of ultra-small sub-wavelength objects 100 that could not be detected in this platform without the use of the vapor-condensed film.

To identify and measure the objects 100, a series of lens-free raw holographic images are first obtained prior to condensation of the vapor on the objects 100. These images provide a baseline signal. Next, the resistive heater 34 is activated with a heating set point temperature such that vapor is created inside the housing 4. For PEG, this temperature may be set to 105° C. During the condensation of this vapor around the objects 100, lens-free images are acquired. In order to generate super-resolution images of the objects 100, low resolution holographic images are taken by serially illuminating the sample 102 from different spatially separated light sources 14. For example, a first image is acquired during illumination by one multi-mode optical fiber 18 powered by its respective LED 16. This is followed by subsequent images being acquired by the different multi-mode optical fibers 18 powered by their respective LED 16 until the different spatially separated light sources 14 have illuminated the sample 102. This process repeats over a period of time as the nanolenses are forming surrounding the objects 100. The evolution of the objects 100 and condensing nanolenses are thus recorded throughout the duration of exposure to the condensing vapor.

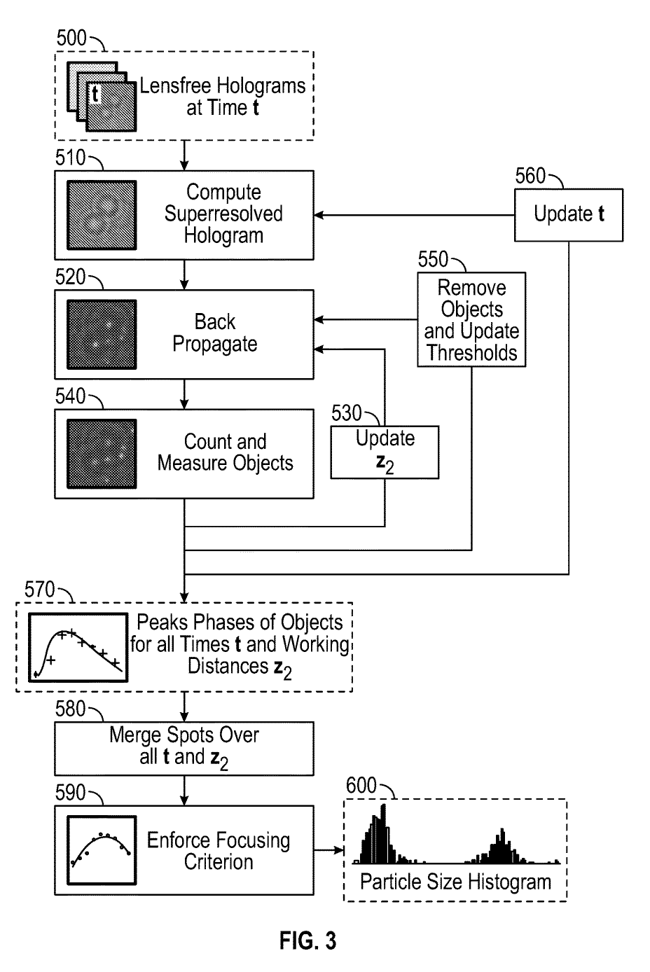

FIG. 3 illustrates a flow chart of one embodiment of an automated object sizing algorithm that is used to count and size objects within a sample. As seen in operation 500 in the FIG. 3, a plurality of low resolution holographic images of the objects 100 are obtained as explained above. Next, as seen in operation 510, these low resolution holographic images are then synthesized by software executed by the one or more processors 42 of the computing device 40 to generate a super-resolved hologram based on the low resolution holographic images obtained. The algorithm used to generate a super-resolved hologram based on a series of low resolution holographic images may be found, for example, in U.S. Patent Application No. 2013-0258091 and in Bishara et al., Lensfree on-Chip Microscopy over a Wide Field-of-View Using Pixel Super-Resolution, Opt. Express, 18, 11181-11191 (2010) which are both incorporated by reference herein.

This pixel super-resolved hologram (which corresponds to a particular time (t)) is then back-propagated to multiple z₂ distances to generate the phase image reconstructions in the vicinity of the object plane as seen in operations 520 and 530. From a particular z₂ reconstruction a count and measure operation is performed as seen in operation 540. In this step, the largest objects 100 are counted, which have a peak phase value greater than a specific pre-set threshold. After counting these larger objects 100, their respective images are “masked” and the associated twin image noise artifacts are digitally removed one by one then the phase threshold value is reduced and the objects 100 that are slightly smaller are counted as seen in operation 550. This iterative count-and-clean procedure is repeated several times (e.g., five times) until the smallest objects 100 are counted. The peak phase value for a particular object 100 is used to generate the size of the object 100 as explained herein. This process is repeated for all pixel super-resolved holograms that were generated over the elapsed time t (step 560) during which images were obtained during the formation and growth of the nanolenses around the objects 100.

Next, as seen in operations 570 and 580 of FIG. 3, the peak phases for all objects 100 at all times t and working distances z₂ is obtained (step 570) and then merged for all times t and working distances z₂ (step 580). In this regard, the algorithm only keeps, for each identified object 100, the largest peak phase value from all times t and working distances z₂. With the peak values obtained for all putative objects 100 that have been identified, there may be some objects 100 that have been identified but are, in reality, spurious non-physical features. These artifacts are then removed by applying an optional focusing criterion as seen in operation 590. As explained in more detail herein, the phase of the object 100 is plotted as a function of reconstruction depth z₂. If the spot represents a real object 100 then this plot will show a clear peak indicating that the object 100 comes into focus at a plausible z₂ (e.g., a parabolic curve is formed). Conversely, spots that do not represent real objects 100 will not display a clear or defined peak in the plot of phase vs. reconstruction depth z₂. These spurious particle-like features or noise can be removed from the dataset. With the objects counted and identified, the respective measurements of the objects 100 is obtained by converting the time-resolved peak phase values for each object 100 with a calibration or empirical curve (or look-up table or the like) that converts the time-resolved peak values to particle size values which can then be reported to the user using the GUI 46. The time-resolved peak values include the peak phase value of each object 100 as a function of working distance (z₂) and condensation time (t). Finally, as seen in operation 600 in FIG. 3, a particle size histogram may be automatically created for all imaged objects 100.

### Experimental

Experiments were conducted on particles using the device illustrated in FIGS. 1A and 1B. The housing was printed using a 3D printer and 17 green colored LEDs were used to provide the source of illumination. The optical bandpass filter used a thin-film interference filter to provide spatial coherence. The image sensor was a 10 mega-pixel complementary metal-oxide-semiconductor (CMOS) image sensor and the sample holder was a transparent substrate made from a plasma-treated microscope cover glass with adsorbed nanoparticles. The entire device weighed less than 500 grams.

Sample Preparation.

The nanoparticle sample of interest is suspended in water. A glass cover slip (size 22×22 mm, thickness ˜150 μm) is used as a substrate. This coverslip is plasma treated using a handheld plasma generator (Electro-Technic Products, BD-10AS) for 30 seconds to ensure the substrate is hydrophilic. A small drop (3-7 μL) of the nanoparticle suspension is deposited on one side of the glass cover slip, and left to rest for between 1 and 5 minutes. After resting, the sample is lightly rinsed with pure deionized (DI) water to remove any salts or surfactants that may have been present in the stock nanoparticle solutions. During this light rinsing procedure, many nanoparticles remain stuck to the substrate and are not washed away. If left to evaporate without rinsing, dissolved salts can form nanoscopic crystals that appear as impurities in the sizing distributions.

Sample Imaging and Nanolens Deposition.

The imaging system used 17 green LEDs coupled to spatially separate multi-mode fibers to provide spatial offset for pixel-super-resolution imaging, an optical bandpass filter (510 nm center wavelength with 10 nm bandwidth), the transparent sample holder to be imaged, and a 10 megapixel, 1.67 μm pixel size, CMOS image sensor with USB readout board (Imaging Development Systems UI-1492LE-M). The backside of the sample holder was placed in contact with the CMOS image sensor, where the downward or front side with the adsorbed nanoparticles is facing away from the image sensor. The distance between the particles and the active area of the sensor is ˜0.9 mm, including both the cover glass thickness and the thickness of the image sensor's protective glass. The imaging system is controlled using a custom-written LabVIEW program.

The nanolens deposition system includes of a reservoir of liquid PEG of molecular weight 300 Da (Sigma-Aldrich, 202371), a small resistive heater submersed within the PEG reservoir for evaporating the PEG (Omega Engineering, KHLV-101/10), and a computer-controlled feedback temperature controller with thermocouple immersed in the PEG used to heat it to a desired temperature (TE Technology, Inc. TC-48-20), and a shutter that can be used to shield the sample from PEG vapor, as desired. The temperature is set and maintained using a LabVIEW program.

The device was operated by first capturing a set of images before condensation to provide a baseline signal. The temperature controller was then activated, with a heating set point of 105° C. During the condensation procedure, lens-free images are acquired. The super-resolution imaging system captured seventeen (17) lens-free holograms for each measurement (for each LED). Capturing these seventeen (17) images takes approximately 3.5 minutes, which can be significantly improved with different frame-grabber hardware systems. Every 4 minutes, a new measurement is performed and a new set of lens-free images captured. The evolution of the sample and condensing PEG nanolenses are recorded throughout the duration of the experiment.

Data Processing and Analysis of Single Particles.

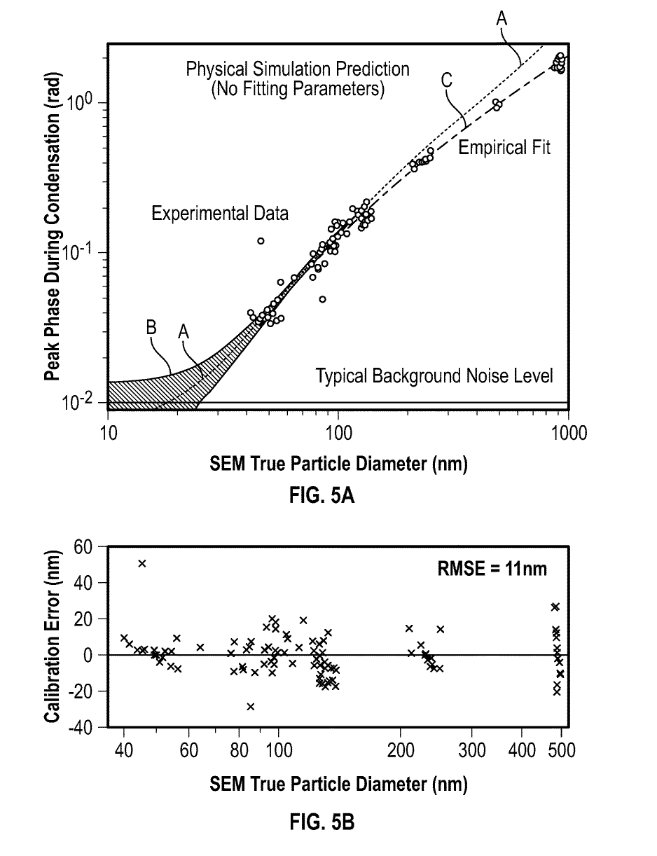

The captured images were processed and analyzed using a custom-written Matlab graphical user interface program (FIG. 2 illustrates the GUI associated with this program). This program synthesizes super-resolved holograms based on each set of 17 raw lens-free frames. It then reconstructs images of the sample based on these holograms using the angular spectrum method. See Goodman J., Introduction to Fourier Optics (Roberts and Company Publishers), 3rd Edition (2004); Mudanyali et al., Compact, light-weight and cost-effective microscope based on lensless incoherent holography for telemedicine applications, Lab Chip 10(11):1417 (2010); and Gorocs et al., On-Chip Biomedical Imaging, Biomed Eng. IEEE Rev In 6:29-46 (2013), all of which are incorporated by reference herein. The program allows the user to easily monitor the images as the condensation progresses by stepping through each time point. It also provides the option to track particular spots in the sample to monitor the local signal change as PEG condenses on the sample. This tracking automatically compensates for drift in x, y, and z of the sample between different time points. The analysis program employs the empirical curve in FIG. 5A to convert time-resolved peak phase values to particle size values, which are reported to the user. The equation for this curve is,

log₁₀(D_{SEM})=0.141 log₁₀(φₚₖ)²+0.906 log₁₀(φₚₖ)−6.30,

where D_{SEM} is the true bead diameter in meters, and φₚₖ is the measured peak phase in radians. Periodically, recalibration of the device may be required to account for changes in the illumination set-up.

Automated Histogram Generation.

To measure particle sizes, the peak phase value of each particle as a function of working distance (z₂) and condensation time (t) is required. Objects on each sample have a distribution of optimal z₂ values resulting from slight tilts of the sample relative to the sensor as well as differently sized particle-nanolens complexes focusing at different distances due to their lensing effects. To account for all this variability, each particle's peak phase is tracked over 9-17 different z₂ values (depending on the tilt for that particular sample), with step sizes of 10 μm between each z₂ value.

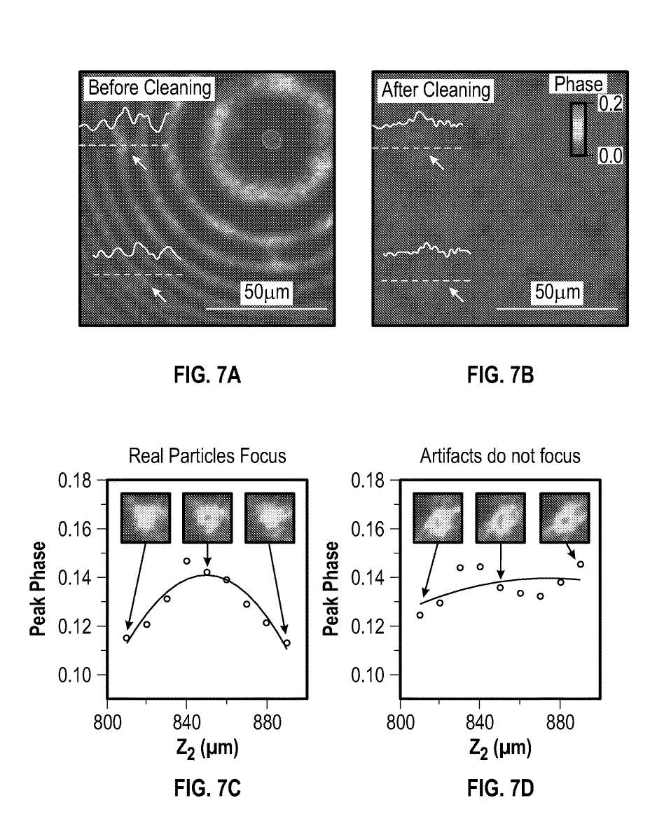

To increase the automated sizing accuracy, the reconstructed optical field is subjected to an iterative particle identification and cleaning process that enables the detection of both large and small particles in the same lens-free reconstructed phase image without mistaking the twin image noise of larger particles as smaller particles. At each iteration, particle candidates whose phase signatures are above a predefined threshold are identified. The peak phases associated with these particle candidates are stored, along with metadata pertaining to the detected particle's coordinates on the image, the z₂ value for the image in which it was detected, and the time point t. After being recorded, the identified particle candidate signatures are then masked from the optical field using a sigmoid function, to be replaced with the mean phase and amplitude around the particle candidate. The same digital masking step is repeated in the twin-image plane, which cleans up the twin-image artifacts in the sample plane. This is particularly useful for dense samples containing large and small particles together, in which the signatures of the small particles can be influenced by the twin image noise of nearby larger particles (see e.g., FIGS. 7A and 7B). This digital cleaning process, but without recording particle data, is also applied on the back-surface of the sample, which occasionally contains dust particles or debris, whose unwanted holograms could otherwise contaminate the measurement of particles on the primary sample surface of interest. The entire particle candidate identification and cleaning process is repeated five times with successively smaller thresholds for each iteration, targeting smaller and smaller particle sizes at each iteration. The final phase threshold is five times the root-mean-square of the background noise (5σ), which is measured for each sample in a region of the image with no particles. Note that a trained user can reliably and blindly identify particles with peak phase as small as 3σ, while reliable automated detection requires the more conservative threshold of 5σ. The total processing time for all 5 iterations over a 1 mm×1 mm region of interest (ROI) using nine z₂ values is less than 11 minutes using a single laptop computer (Lenovo T530, 16 GB RAM memory and Intel i7-3720QM processor). As all the automated nanoparticle counting steps can be processed in parallel for different ROIs, a cluster of 30 nodes (quad-core machines) would enable the entire FOV reconstruction to be performed within ˜11 minutes. Using graphics processing units (GPUs) instead of central processing units (CPUs) would speed up the total particle distribution measurement time by a factor of 10-20-fold, as the algorithms heavily rely on fast Fourier transforms. Optimized algorithms implemented using more efficient software languages, such as C/C++, would also improve data processing times over the Matlab routines used here. Therefore, even with a single laptop computer employing GPUs, the entire processing time for a full FOV nanoparticle sizing measurement to be reduced to under a few minutes.

Particles of different sizes reach their optimum peak phase signal at different times (t). To take this variability into account, the peak phase of each particle candidate is tracked over all relevant time points. These data, along with the peak phase values as a function of z₂ are then merged to match particle candidates between each image based on the particles' (x, y) coordinates.

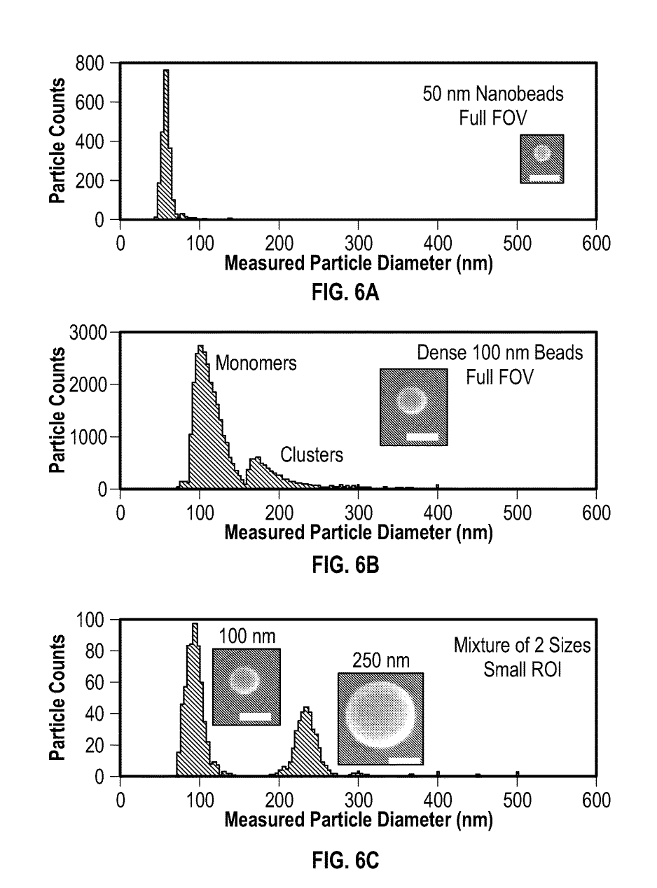

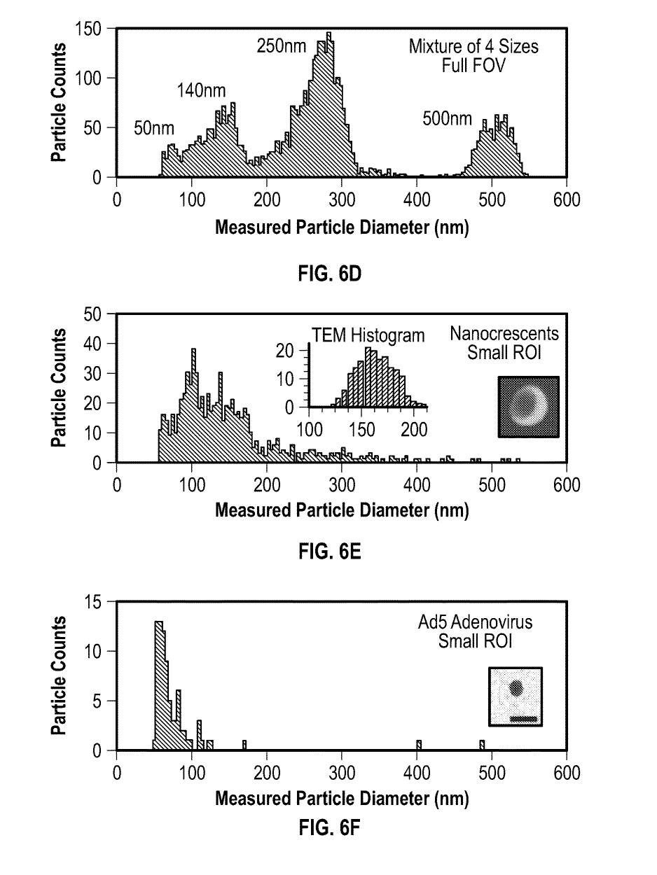

To mitigate false positives in the particle detection process, a focusing criterion (see FIGS. 7C and 7D) on each particle candidate is also employed, which is evaluated after all particle candidates have been identified. This criterion is based on the premise that true “physical” particles on the sample will exhibit a peak in the reconstructed phase signal as they come into the correct depth of focus, while false particles (i.e., noise terms) do not exhibit this peak in signal as a function of reconstruction depth, z₂. To quantify these focusing characteristics, a parabola is fit to the peak phase as a function of z₂. To classify a particle candidate as a true particle (1) the coefficient of the quadratic term of the fitted parabola must be smaller than −10⁻⁶ rad/μm²; (2) the parabola peak must be within the range of z₂ values that were tracked; and (3) the R-squared goodness-of-fit must be better than 0.5. Only the particles that pass all of these three sub-criteria are reported in the particle size histograms (see e.g., FIGS. 6A-6F).

In the experiments, a set of low-resolution holograms are acquired before any vapor condensation occurs in order to provide a baseline image. Particles that are smaller than several hundred nanometers are undetectable in each one of these lens-free images. The heater is then activated and set to 105° C. using a feedback temperature controller. Higher temperatures can be used for faster operation, but with less precision in results. After the system reaches the set temperature (within ˜4 min), another set of low-resolution lens-free holograms are acquired, with a period of e.g., 4 min. These sets of time-resolved lens-free holograms are much more reliable than a single lens-free measurement at a given time point, and enable us to accurately size a large range of particles with various compositions while also making the platform immune to experimental fluctuations in e.g., condensation rate, vapor density, etc.

During and after data acquisition, a custom-written graphical user interface such as that illustrated in FIG. 2 for processing the acquired images is used. The graphical interface is run on a separate computer that is coupled to the hand held device via a cable or the like such that images captured via the image sensor can be offloaded for image processing. This graphical interface processes and presents a large amount of information rapidly and in a convenient fashion, including the raw low-resolution holograms, high-resolution holograms synthesized using pixel super resolution, digitally-reconstructed images of the sample, and time-traces of the signal from individual particles during the course of the experiment. The interface also automatically compensates for possible mechanical drifts in x, y, and z of the sample between different time points. Because this method uses a digital holographic approach, both amplitude images (similar to brightfield) and phase images (similar to phase contrast) are available after digital reconstruction. For the nanolens-nanoparticle complexes experimented with, it was found that the phase images were more sensitive and this information channel was used to define the “signal” of the particles that were imaged and quantified. The measured optical phase is proportional to the product of the refractive index and the thickness of the sample and is a measure of the delay of a light wave as it travels through the sample.

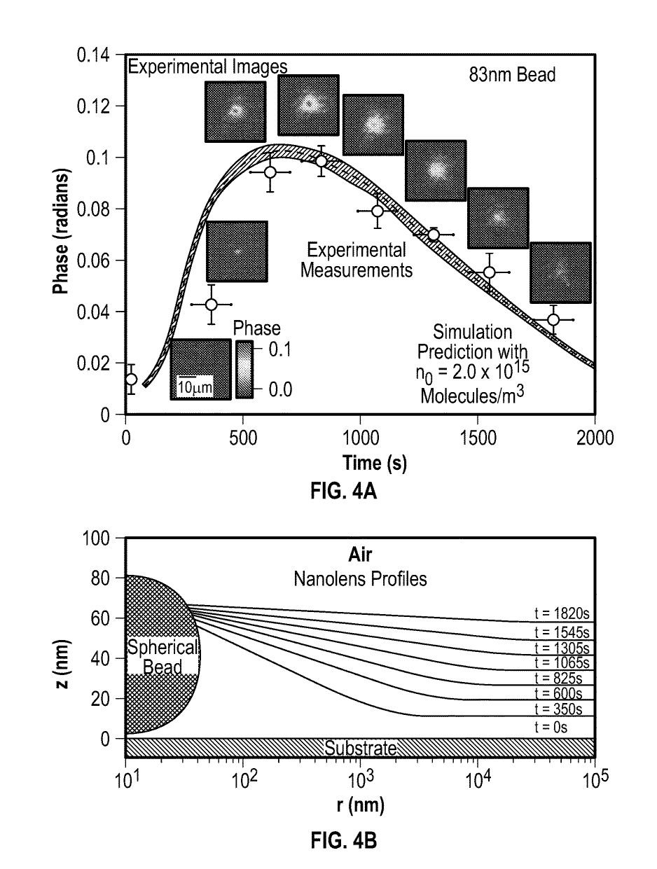

During the course of each experiment, PEG will evaporate from its reservoir due to its elevated temperature. Some of this PEG vapor will then condense on the cooler sample surface. As the PEG condenses on the sample, it forms a continuous film that thickens over time. In the vicinity of nanoparticles adsorbed on the substrate, this continuous film rises in the form of a meniscus that acts as a nanolens that increases the scattering from the particle and helps to direct light toward the image sensor, thereby boosting the particle's heterodyne holographic signature (FIG. 4A). This increase in holographic signature enables the detection of ultra-small sub-wavelength particles that could not be detected in this platform without the use of the vapor-condensed film, such as the 83 nm bead example shown in FIG. 4A, whose size was verified using SEM. After sufficient vapor condensation, the PEG film becomes so thick that it begins to bury the nanoparticle under a thick layer, resulting in a loss of signal at late exposure times. In FIG. 4A, this behavior is seen in both the experimental results (filled black circles and accompanying reconstructed lens-free images inset in FIG. 4A), as well as the simulated results (curve). These simulations include 1% random white Gaussian noise added at the image sensor (hologram) plane, which generates the small spread in simulation results whose span is indicated by the shaded region along the curve. These simulation results depend on a single fitting parameter, the vapor density, which is here assumed to be 2.0×10¹⁵ molecules/m³. With this single fitting parameter, there is good agreement between the simulations and the experimental results for this 83 nm bead. The simulations used here incorporate physical modeling of the shape of the nanolens as a function of time as seen in FIG. 4B, as well as optical simulations of the hologram formation and reconstruction process.

Beyond verifying the simulations, the time-resolved lens-free measurements to identify and record the maximum signal obtained over the course of the experiment, which correlates strongly with particle size as detailed below. Therefore, time-resolving the optimum phase signal value instead of the signal value at a specific fixed time period maximizes the sensitivity of this approach to small particles and improves sizing accuracy by making the procedure robust to variable heating temperatures and unknown vapor densities.

In FIG. 5A the same analysis shown in FIG. 4A was done for 121 other spherical particles in order to test the repeatability and accuracy of the sizing platform. FIG. 5A plots the time-resolved maximum phase signal (e.g., the phase value of the uppermost black circle in FIG. 5A) as a function of the true particle size, which was measured using SEM. The points plotted here are drawn from five (5) different experiments each with mixtures of bead sizes and 16-32 beads per experiment, where the throughput in this specific case has been limited by the process of acquiring SEM comparison images. The experiments had overlapping size ranges to ensure repeatability between experiments as well as consistency among beads within a single experiment. The limit in these experiments in the smallest detectable particle size to be approximately 40 nm, which very well coincides with 3 times the typical background noise (standard deviation of the pixels in a region without any particles), which is of order 0.01 radians.

The curve A in FIG. 5A shows the simulated prediction for the reconstructed peak phases of detected particles based on modeling of the vapor-condensed nanolens shape and its influence on optical scattering. It is important to note that this curve involves no fitting parameters, as the peak phase value is independent of the PEG vapor density (although the time at which this peak signal is achieved is dependent on the vapor density)—this is an important example of how time-resolved holographic imaging significantly improves the detection sensitivity while also making measurements more repeatable and robust to experimental factors. The shaded region B in FIG. 5A encompassing the line A shows the standard deviation in the spread of eight different simulation results using different random noise fields added at the sensor plane. The good agreement between the experimental results and this physical model (without any fitting parameters) also illustrates the success of the theoretical modeling and understanding of the mechanisms behind the contrast enhancement provided by the vapor-condensed nanolenses. For particles larger than several hundred nanometers, a small divergence is noticed between the predictions and the experimental results. This divergence can be a result of the thin-lens approximation used to model the nanoparticle-nanolens system, which works well for small particles, but not as well for larger particles.

While curve A demonstrates the physical modelling of the system, the curve C in FIG. 5A is the more practically useful calibration curve for evaluating this system as a particle sizing platform. This curve C is an empirical second order polynomial fit (in log-space) to the experimental data, and it serves as a calibration curve for the platform that provides the best one-to-one relationship between the measured peak phase and the true particle diameter. The sizing error between the experimental data and the true particle size is shown in FIG. 5B. For particles between 40 nm and 500 nm, the root-mean-square error is +/−11 nm, which is relatively independent of particle size, indicating that it is better to characterize the error as an absolute error rather than a relative (percentage) error in this size range.

With the calibration curve determined, this platform was applied to blind sizing of large numbers of nanoparticles. In FIGS. 6A-6F, histogram sizing results from several types of samples are shown, including monodisperse polymer nanospheres (FIGS. 6A and 6B), polydisperse polymer nanospheres (FIGS. 6C and 6D), nonspherical inorganic particles (FIG. 6E), and viruses (FIG. 6F). FIG. 6A depicts the sizing of 50 nm particles, which are close to the minimum measurable size. FIG. 6B shows the measurement results from a dense sample of 100 nm beads, where more than 32,000 beads were measured. Due to the density of the sample, a secondary peak corresponding to particle clusters is also observed. The platform is estimated to detect particle surface densities in excess of 1 particle per (5 μm)², enabling imaging and sizing of more than 10⁶ particles across the full 30 mm² active area of the sensor-array, although clusters will also be present. FIGS. 6C and 6D demonstrate that using the presented computational lens-free on-chip imaging approach, it is possible to accurately size heterogeneous nanoparticle populations that are typically very challenging for even benchtop DLS instruments.

The gadolinium-silica core-shell nanocrescent moon shape particle in FIG. 6E is another example of a sample that is very challenging for DLS due to the non-spherical nature of these particles. These nanocrescents are expected to find uses as high contrast magnetic resonance imaging agents. For this sample, manual TEM sizing (see the inset in FIG. 6E) showed that the particle diameters ranged from 120 nm to 200 nm. The results show many particles in this range, but some particles smaller than 120 nm were also measured. This discrepancy may be partially due to the use of a spherical bead calibration curve to size non-spherical particles. While these particles' true diameters are in the range 120 nm-200 nm, their true heights (chords) are typically much smaller (˜50 nm). Therefore, one would expect these non-standard half-shell particles to be sized similar to nanospheres with diameters somewhere between 50 nm and 200 nm, depending on the orientation of the individual particle with respect to the substrate, along with its size. Although the nanolens-based sizing approach used here is more sensitive to the height of the nanoparticle and therefore is not as accurate as TEM for these non-spherical particles, it still remains very useful for approximate sizing and particle distribution measurements, significantly out-performing the capabilities of traditional DLS techniques.

Next, FIG. 6F demonstrates the applicability of this technique to the sizing of biological particles, where the platform successfully sized Ad5 adenoviruses, whose typical sizes range from 50-80 nm. These viral particle sizing measurements could be potentially useful for viral load monitoring in resource limited settings or for quality control in the culturing and purification of viruses for e.g., vaccine and anti-viral drug development efforts.

To generate the histograms in FIGS. 6A-6F, automated segmentation algorithm was used to localize and size particles based on lens-free phase image reconstructions. The approach here was custom-developed in order to correctly identify and size very small particles, which in some cases generated signals that were very similar to twin-image noise that was present around larger particles or to random background noise. The “count and clean” algorithm begins by computing a super-resolved hologram from a set of low-resolution raw images. This pixel super-resolved hologram is then back-propagated to multiple z₂ distances to generate the phase image reconstructions in the vicinity of the object plane. From this reconstruction the largest objects are first counted, which have a peak phase value greater than a specific threshold. After counting these larger particles, their associated twin image noise artifacts are digitally removed one by one. Next, the phase threshold value is reduced and the particles that are slightly smaller are counted. This iterative count-and-clean procedure is repeated five times, until the smallest particles (those with diameter ˜40-50 nm) are counted.

The benefits of this iterative count-and-clean algorithm can be seen in FIGS. 7A and 7B, where 56 nm and 40 nm particles that were initially buried in the twin image noise of a larger (˜590 nm) particle become clearly visible after the larger particle has been counted and its signature digitally removed from the lens-free image. To find the peak phase as a function of time (e.g. FIG. 4A), which is correlated with the particle size (FIG. 5A), this analysis was repeated over all the time-resolved lens-free images. The peak phase data was then merged so that for each spot, only the largest peak phase found out of all the z₂ and time values t is kept. Through calibration experiments, it was found that there are often a number of false positives, i.e., particle-like noisy features that appear in the reconstructed phase images, especially when imaging <70 nm particles. To be able to automatically reject such spurious non-physical features and therefore significantly reduce the false characterization rate, an additional focusing criterion is applied to separate physical particles from random noise: for each spot of interest that falls within the dynamic phase threshold value for particle sizing, plotting the phase as a function of reconstruction depth (z₂) must show a clear peak, indicating that the particle comes into focus at a plausible z₂. FIGS. 7C and 7D illustrate an example of a particle that focuses well and an example of a spurious particle-like feature that does not focus well, respectively. After this additional “focusing criterion” is applied, the aggregate set of peak phases that show focusing behavior are converted to particle sizes using the calibration curve from FIG. 5A, and are plotted as histograms (e.g., FIGS. 6A-6F). This automated particle detection algorithm is capable of accurately identifying particles larger than ˜50 nm, making it slightly less sensitive than a human observer operating the graphical user interface program (FIG. 2), where the platform can achieve reliable detection of individual nanoparticles relative to background noise down to ˜40 nm, which also coincides with 3 times the typical background noise in the phase reconstruction images.

The platform described herein enables the high-throughput and label-free nanoparticle sizing individual nanoparticles as small as ˜40 nm with an accuracy of +/−11 nm using self-assembled nanolenses and on-chip microscopy, all in a portable and cost-effective instrument. This platform includes the necessary hardware for vaporizing PEG and time-resolved imaging of nanoparticle samples, along with the necessary software for controlling the nanolens formation and imaging sequence, and for automated processing of the resulting data cube. This platform will provide an alternative to electron microscopy in resource-limited settings (at least for particle detection and sizing needs), as well as an alternative to dynamic light scattering and other optical sizing methods when location-specific sizing distribution is required of individual nanoparticles in a complex heterogeneous sample.

While embodiments of the present invention have been shown and described, various modifications may be made without departing from the scope of the present invention. The invention, therefore, should not be limited except to the following claims and their equivalents.

1. A device for the imaging and sizing of objects within a sample comprising:
a housing having an interior volume therein;
an image sensor disposed in an upper portion of the housing and having an active region facing towards the interior volume;
a sample holder having a lower surface that contains the objects thereon, the sample holder insertable into the housing adjacent to the active region of the image sensor;
a fluid chamber disposed in the housing and exposed to the interior volume and having a heating element therein, the fluid chamber configured to hold a liquid therein; and
an array of spatially separated light sources disposed in the housing and defining an optical path between the array of spatially separated light sources and the active region of the image sensor, wherein the sample holder, when inserted, is positioned within the optical path.

2. The device of claim 1, further comprising a computing device having one or more processors configured to generate time-resolved, super-resolution holograms from a plurality of low-resolution image frames obtained of the objects by the image sensor when illuminated by the spatially separated light sources and extract peak phase values from phase image reconstructions obtained from the super-resolution holograms, wherein the one or more processors outputs a size of the objects based on the peak phase value values.

3. The device of claim 1, wherein the fluid chamber contains polyethylene glycol (PEG).

4. The device of claim 1, wherein the fluid chamber contains water.

5. The device of claim 1, further comprising a computing device having one or more processors configured to generate time-resolved, super-resolution holograms from a plurality of low-resolution image frames obtained of the objects by the image sensor when illuminated by the spatially separated light sources, wherein the image frames are obtained over a period of time t.

6. The device of claim 5, wherein the one or more processors are configured to back-propagate the super-resolved holograms obtained over the period of time t to multiple z₂ distances to generate phase image reconstructions of the objects.

7. The device of claim 6, wherein the one or more processors are configured to recover peak phase values of the objects as a function of distance z₂ and time t.

8. The device of claim 7, wherein the one or more processors are configured to count the objects and iteratively remove those objects from the phase image reconstructions having a peak phase value above a decreasing threshold value followed by recovering peak phase values for the remaining objects after the removal.

9. The device of claim 8, wherein the one or more processors are configured to merge peak phase values for all objects as function of distance z₂ and time t.

10. The device of claim 9, wherein the one or more processors applying a focusing criterion to remove spurious objects based on peak phase values as a function of z₂ values.

11. The device of claim 10, the one or more processors configured to identify the peak phase value for remaining non-spurious objects and outputting an object count and size of the counted objects based on the identified peak phase value.

12. The device of claim 5, the one or more processors are configured to track peak phase values for each object for all or some z₂ and t values.

13. A method of imaging and sizing objects comprising:
loading the objects on a substrate;
subjecting the substrate to evaporated liquid that forms nanolenses over the objects;
obtaining a plurality of low-resolution image frames of the objects at multiple times t using an array of spatially separated light sources and an image sensor, wherein the objects of interest are located within an optical path between the spatially separated light sources and the image sensor;
generating a super-resolved hologram from a plurality of low-resolution image frames obtained of the objects by the image sensor obtained at the multiple times t;
back-propagating the super-resolved hologram to multiple z₂ distances;
recovering phase images of the objects and counting objects having a phase value over a threshold value;
masking the already counted objects and measuring the phase value of remaining objects and counting objects having a phase value over a reduced threshold, wherein this step is repeated a plurality of times;
merging peak phase values for each object for all z₂ and t values;
applying a focusing criterion to remove spurious objects based on z₂ values; and
identifying the peak phase value for remaining non-spurious objects and outputting a size based on the identified peak phase value for the remaining non-spurious objects.

14. The method of claim 13, wherein the substrate, spatially separated light sources, image sensor, and the evaporated liquid are contained within a single portable, handheld device.

15. The method of claim 13, wherein the liquid comprises PEG or water.

16. The method of claim 13, wherein at least some of the objects comprise nanometer or micrometer sized particles.

17. The method of claim 13, wherein the objects range from about 40 nm to millimeter-sized objects.

18. The method of claim 13, wherein the substrate is continuously exposed evaporated liquid for several minutes.

19. The method of claim 13, wherein the masking operation is performed between 2 and 5 times.

20. A device for the imaging and sizing of objects within a sample comprising:
a housing having an interior volume therein;
an image sensor disposed in the housing and having an active region facing towards the interior volume;
a sample holder having a surface that contains the objects thereon, the sample holder insertable into the housing adjacent to the active region of the image sensor;
a fluid chamber disposed in the housing and exposed to the interior volume and having a heating element therein, the fluid chamber configured to hold a liquid therein; and
one or more light sources disposed in the housing and defining an optical path between the one or more light sources and the active region of the image sensor, wherein the sample holder, when inserted, is positioned within the optical path.

21. The device of claim 20, wherein the one or more light sources comprises an array of spatially separated light sources.
